(19) United States
(12) Patent Application Publication
(10) Pub. No.: US 2026/0178830 A1
(43) Pub. Date: Jun. 25, 2026

(54) COMPOSITIONALITY IN WEB AUTOMATION VIA CONSTRAINED HIERARCHICAL PLANNING OVER A SEMANTIC UI STATE-ACTION SPACE

(71) Applicant: International Business Machines Corporation, Armonk, NY (US)

(72) Inventors: Orit Davidovich, Kiryat Tivon (IL); Alexander Zadorojniy, HAIFA (IL); Yishai Abraham Feldman, Tel Aviv (IL)

(73) Assignee: International Business Machines Corporation, Armonk, NY (US)

(21) Appl. No.: 18/991,502

(22) Filed: Dec. 21, 2024

(51) Int. Cl. G06F 40/211; G06F 40/226

(52) U.S. Cl. CPC G06F 40/211; G06F 40/226

(57) ABSTRACT

An embodiment includes semantically parsing UI flows to identify subtasks. The embodiment also includes modeling subtasks within a semantic user interface state-action space (UI SAS). The embodiment also includes providing states, actions and their parameters with names that encapsulate each a semantically discrete purpose, thus making them interpretable. The embodiment also includes updating the UI SAS as new UI flows are added. The embodiment also includes generating, via a planning agent, an action sequence as a route in the UI SAS corresponding to a requested task expressed in a user utterance. The embodiment also includes parsing the action sequence for syntactic errors. The embodiment also includes providing feedback to the planning agent to correct the action. The embodiment also includes executing the syntactically validated action sequence, via an execution agent, to perform the requested task within one or more web applications.

### BACKGROUND

The present invention relates generally to compositionality in web automation. More particularly, the present invention relates to compositionality in web automation via constrained hierarchical planning over a semantic user-interface (UI) state-action space using large language model (LLM) agents.

Web Automation, or autonomous web navigation, refers to the use of software tools and scripts to automate patterns that involve common tasks and processes that are typically performed manually on web browsers and online platforms. This can include actions like filling out forms, information seeking, scraping data, clicking buttons, navigating web pages, and performing repetitive tasks across websites without human intervention. Web automation is intended to give end-users the full power of programming in web applications without requiring them to learn or apply a formal language. Generating an automated routine may be as simple for the user as initializing a recording, performing the series of keystrokes and mouse clicks that constitute the task to be automated, and ending the recording when the task is completed.

Automation can significantly reduce the time required to complete repetitive tasks by allowing software to handle these processes. Automation allows businesses to handle larger volumes of work without needing to proportionally increase workforce size. This may lower labor costs associated with performing those tasks manually and lead to resource savings across an enterprise. Additionally, automated tasks can remove human error, ensuring that actions are performed more consistently than manual processes.

In practice, however developments towards this end in web application environments have been hampered due to web automation to date being inherently fragile. For example, automated routines tend to break when webpages change (e.g., page object properties change, processes shift) and are rarely able to reproduce the full functionality that a user would be able to access within a web application.

Real-world web application settings are open ended as a result of operating in diverse and unpredictable system architecture and environments, where various factors can influence their behavior, functionality, and user interactions. There is no clear, fixed set of actions and no clear feedback signal, so rigidly defined automation routines would likely have limited applicability, potentially having applicability in only one conditional state of one web page. Even then, such a rigidly defined routine would likely be incapable of adapting to updates to that one web page that a human user would have no issues navigating.

Additionally, automated routines often rely on rewards or feedback as observation signals indicating task completion in order to operate correctly. Examples of such rewards or feedback may include, but are not limited to, messages indicating that a previous step has been completed (i.e. “Your information has been successfully submitted”) prior to moving to the next step of the routine, error messages or error states that indicate the routine will not be able to execute or that an alternate branch of the routine should be executed instead. In real-world web application settings, such rewards or feedback may be nonexistent, sparse, or delayed, so that web exploration episodes may generate no reward signal at all. For example, lagging server response can mess up observation signals in response to UI interactions. Without a robust supply of rewards and feedback, an automated routine may functionally be operating in the dark.

Reliance on rigidly defined automation routines, each responsible for executing one specific action from one conditional state of a web application, to fully model all the possible functions within a web application would quickly become cumbersome to the point of being unmanageable. Unless constrained, a full model of a web application would require multiple actions between web application states resulting from hundreds of possible UI interactions on each page, an average of approximately six hundred (600) elements per app webpage in the Mind2web dataset. Thus, gathering human demonstrations for the purpose of training does not scale.

While developments have been made towards providing the end-user with resilient, user-friendly, no- or low-code UI automation tools, there still exists a need for a method to enable compositionality in web automation. As used herein, “compositionality”, also known as “compositional generalization”, refers to the idea that complex expressions are constructed from less complex expressions that are their constituents. In the context of web automation, compositionality would allow for the utilization of components of previously learned web tasks to control browsers to perform unseen tasks. In the process, novel combinations would be produced from learned admissible components.

Compositionality is distinct from “end-to-end teaching” or “end-to-end flows”. An end-to-end UI flow refers to a holistic approach where a natural language input triggers an entire sequence of UI interactions, from start to finish, in one continuous, pre-defined flow. A system interprets a complete user instruction or intent and executes the entire process as a single unit, from the initial UI interaction to the final outcome. The input is treated as a single, cohesive task rather than breaking it into smaller components.

While an end-to-end approach can be effective for simple tasks requiring few steps or those tasks which can be performed within a single application, compositionality will tend to outperform the end-to-end approach in the context of complex tasks and tasks that require actions across multiple applications. Additionally, since each end-to-end flow is interpreted as a single discrete routine, end-to-end systems may require new flows to be defined for each new task variant, which can be less flexible, scalable, and versatile.

### SUMMARY

The illustrative embodiments provide for compositionality in web automation via constrained hierarchical planning over a semantic UI state-action space. An embodiment includes parsing UI flows to identify app states, actions and their parameters. The embodiment also includes naming the identified app states, actions and their parameters in a way that aligns with their functionality as it may be understood by a user. The embodiment also includes combining all app states, actions and their parameters into a semantic UI state-action space representation of the web application. The embodiment also includes updating the semantic UI state-action space as UI flows are added, amended, or deleted. The embodiment also includes modeling tasks as paths within the semantic UI state-action space. The embodiment also includes generating, via a planning agent, an action sequence corresponding to an intent expressed in an utterance by a user. The embodiment also includes parsing the action sequence for syntax errors. The embodiment also includes executing the validated action sequence to perform the requested task within one or more web applications. The embodiment also includes responding dynamically to execution errors via feedback to the planning agent that may either result in an amended action sequence or in a request for information from the user. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example system for compositionality in web automation via constrained hierarchical planning over a semantic user-interface state-action space using large language model (LLM) agents in accordance with an illustrative embodiment;

FIG. 3 depicts a block diagram of a high-level conceptual framework of compositionality in UI flows in accordance with an illustrative embodiment;

FIG. 4 depicts an example a semantic UI state-action space 400 (UI SAS) in accordance with an illustrative embodiment; and

FIG. 5 depicts a flowchart of example processes for compositionality in web automation over a semantic UI state-action space in accordance with an illustrative embodiment.

### DETAILED DESCRIPTION

The present disclosure addresses the deficiencies described above in the Background section by providing a process (as well as a system, method, machine-readable medium, etc.) that develops web automation via constrained hierarchical planning over semantic UI state-action space representations of web applications. Disclosed embodiments combine natural language (NL) processing a user's utterance for the task being requested and a semantically-structured model of web applications or systems to cross-reference the high-level task with a corresponding set of actions identified within prior UI flows. As used herein, the term “utterance” refers to an input intended to convey a request or instruction for a task to be executed end to end. Utterance may include, but are not limited to, natural language expressions, either textual or verbal, emojis or other visual representations of meaning, gestures, sign language, or the like or combinations thereof.

Compositionality affords the ability to utilize components of learned web application tasks to control browsers to perform unseen tasks. In the process, novel combinations are produced from learned admissible components. Thus, compositionality may allow the user to automate UI flows without having to teach them end-to-end, so long as their constituents have been previously taught.

Compositionality further allows the user to teach the system to automate from the middle, eliminating the need for the user to repeatedly perform subsequences of UI interactions that occur in multiple tasks. The user has the option to teach from whichever point in the UI flow they choose. Compositionality, as an embedded principle, also allows the system to seamlessly combine several web applications into a single UI flow. As an example of its usefulness, a consulting sales representative may use up to nine (9) separate applications in the execution of routine tasks.

By introducing hierarchical planning into web automation, compositionality may allow for a separation between distinct concerns in planning. As used herein, “planning” refers to the process of generating a sequence of actions that a system is able to execute in order to fulfill a user's request. Thus a “planner” or “planning agent”, as used herein, refers to a component that interprets requests from a user and generates a series of executable actions that fulfils such request.

“Hierarchical planning,” as used herein, refers to separating the latent overall plan from the execution of each one of its components, with high-level goals (abstract tasks) focusing on broader objectives and low-level actions, consisting of primitive UI interactions, focusing on the concrete steps to execute them. As used herein, “primitive UI interactions” refers to most the basic, indivisible interactions that can be performed within the interface. These interactions involve fundamental maneuvers that typically cannot be broken down into smaller interactions within the context of the UI. Primitive UI interactions serve as the building blocks of more complex workflows and are critical in automation, as they allow for precise, granular control over user behavior in the application. Examples of “primitive UI interactions” include but are not limited to clicking, entering text, selecting, hovering, scrolling, dragging, dropping, zooming, submitting, and the like.

A high-level planner may plan a novel flow in response to user intent, relying on previously automated components, while a low-level planner resiliently enacts each step of the plan along the way. Thus, a high-level planner may address the compounding errors which are the hallmark of the end-to-end, one-step-at-a-time approach to complex tasks.

With compositionality, the risk of executing novel, untested tasks may be addressed by constraining the space of allowed actions, building on top of tested, admissible components. As the behaviors of each of the tested components are known to be stable and predictable, the behavior of the novel task constructed from the tested components should likewise be stable and predictable. This is relevant for safety-critical domains, where exploration of novel behaviors is prohibitively costly or dangerous.

From one point of view, web automation may be thought of as a sequential decision-making problem in which a planning agent must take action within a structured browser environment to follow user instructions given in natural language (NL). It requires a model or representation of the web application that captures those aspects of its webpages or screens that are relevant to decisions applicable to tasks of interest.

In some instances, such a model or representation of the web application may be a partial model. As used herein, “partial model” refers to a representation of web application or other system upon which the user may instruct the planning agent to execute requests wherein the representation does not completely describe the full functionality of the application or system. As a full model may require description of hundreds of possible states and actions within a web application, where the vast majority would remain irrelevant to a given task, the ability to operate with a partial model is often preferable.

The illustrative embodiments provide for compositionality in web automation via constrained hierarchical planning over a semantic user-interface state-action space. “Semantic”, as used herein, refers to extracted meaning of an expression, particularly such that the meaning can be conveyed in a different form. Examples of applications of semantics include, but are not limited to, converting a user's natural language request into machine executable instructions or interpreting the purpose of machine executable instructions in natural language terms that a user can easily understand. Semantic representations may allow high-level actions in the model to remain meaningful to the user, and then be translated into low-level actions in multiple ways, depending on the particular structure of a webpage at a particular time.

The following description provides examples of embodiments of the present disclosure, and variations and substitutions may be made in other embodiments. Several examples will now be provided to further clarify various aspects of the present disclosure.

Example 1: A computer-implemented method that comprises separating UI flows into a plurality of identifiable structural components and naming the structural components. The method further comprises modeling the plurality of structural components as a plurality of representations within a user interface state-action space (UI SAS). The method further comprises generating, via a planning agent, an action sequence comprising a sequence of subtasks representing an utterance from a user. The utterance comprises an input intended to convey a requested task to be executed within the one or more web applications. The method further comprises parsing, via a validator, the action sequence for syntactic errors. The method further comprises generating, via the validator, a validated action sequence. The method further comprises executing, via an execution agent, the validated action sequence to perform the requested task within one or more web applications.

The above limitations advantageously enable resilient, user-friendly, no- or low-code UI automation of user-defined tasks within and across web applications. Separating UI flows into identifiable structural components and naming the structural components enables compositionality of UI flows and the composition of new, complex UI flows from previously defined subtasks. Reliance on a library of UI flows stored in a flow database as source material ensures the functionality of the derived subtasks and subsequent action sequences composed therefrom. Modeling subtasks into a UI SAS enables discovery of state-action space connections between subtasks, thus enabling subtasks to be arranged into action sequences not previously described within existing UI flows. The representations within the UI SAS enable increased structure beyond what can be found in the user's utterance but retains a level of semantic abstraction, enabling contextual sensitivity to remain more flexible and adaptive than hard-coded machine instructions. Validation ensures that the action sequence, which is coherent at the abstract, conceptual level, also coheres at the granular, executable level.

Example 2: The limitations of Example 1, wherein a UI flow corresponds to a task to be executed within one or more web applications. The above limitations advantageously enable complex UI flows which extend beyond the functionality of a single web application. Further, by parsing such complex UI flows into subtasks, new cross-functional action sequences may be composed of tested and verified subtasks, enabling greater stability when the user requests novel and complex tasks to be executed.

Example 3: The limitations of Example 1, wherein an action comprises a plurality of primitive UI interactions that complete a discrete purpose within the task, terminating in a boundary UI interaction. The above limitations advantageously enable rule-based parsing of UI flows into subtasks and allows high-level abstractions of task steps to correlate strongly with the discrete purposes associated with the subtasks.

Example 4: The limitations of Example 1, wherein a representation within the plurality of representations within the UI SAS comprises an assignment of meaningful names to a plurality of states, actions, and parameters. The above limitations advantageously enable semantic correlations between the functional properties of a plurality of states, actions, and parameters, thus strengthening the action sequence interpretation at the abstract, conceptual level with the representations in the UI SAS.

Example 5: The limitations of Example 4, wherein the meaningful names are determined via a semantic analysis of the semantically discrete purpose of the plurality of primitive UI interactions. The above limitations advantageously enable rule-based assignment of meaningful names, thus a rule-based process of achieving the benefits laid out in Example 4.

Example 6: The limitations of Example 1, wherein generating the action sequence further comprises tracing, via the planning agent, a route through the plurality of representations modeled within the UI SAS. The above limitations advantageously enable the planning agent to leverage the constraints inherent in the UI SAS model to ensure that the action sequence generated is composed of valid, tested subtasks, thus providing more stable and reliable action sequences.

Example 7: The limitations of Example 1, wherein the utterance from the user comprises a natural language input. The above limitations advantageously enable a simple and intuitive user interface through which to request even the most complex tasks.

Example 8: The limitations of Example 1, wherein the planning agent comprises a large language model (LLM). The above limitations advantageously enable the planning agent to navigate the inherent ambiguity with both the user's utterance and the semantic structuring of the UI SAS through the LLM's interpretive flexibility to generate an action sequence compatible with both the request and the model.

Example 9: The limitations of Example 1, wherein the flow database is populated by UI flows consisting of sequences of primitive UI interaction. The above limitations advantageously enable a simple and intuitive user interface through which to provide the UI flows needed to build the UI SAS.

Example 10: The limitations of Example 1, the flow database is populated via program by demonstration to capture UI events. The above limitations advantageously enable precise, step-by-step guidance for UI flows without requiring coding knowledge or inputs.

Example 11: A computer program product comprising one or more computer readable storage media, and program instructions collectively stored on the one or more computer readable storage media, the program instructions comprising instructions configured to cause one or more processors to perform the method according to any of Examples 1-10. The computer program product of Example 11 realizes the benefits described with respect to Examples 1-10. The computer program product of Example 11 can advantageously be implemented into a variety of computer program products.

Example 12: A computer system comprising one or more processors and one or more computer-readable storage media collectively storing program instructions which, when executed by the one or more processors, are configured to cause the one or more processors to perform the method according to any of Example 1-10. The system of Example 12 realizes the benefits described with respect Examples 1-10. The system of Example 12 can advantageously be implemented into a variety of computing devices.

Example 13: A computer-implemented method that comprises tracing, via a high-level planner, a route through a user interface state-action space (UI SAS), the route corresponding to a user-provided utterance that conveys a requested task to be executed. The UI SAS comprises a model representing a plurality of relevant states of one or more web applications and a corresponding plurality of actions (parametrized or not) that can be made from the plurality of states. The method further comprises generating, via the high-level planner, an action sequence for a low-level planner comprising a sequence of states of the plurality of states and a corresponding sequence of actions of the plurality of actions. The method further comprises generating, via the validator, a validated action sequence by parsing the action sequence for syntactic discrepancies within the sequence of states and the corresponding sequence of actions. The method further comprises executing, via a low-level execution agent, the validated action sequence to perform the requested task within one or more web applications.

The above limitations advantageously enable compositionality in web automation. The UI SAS representation of the one or more web applications enables separation of concerns into high- and low-level planning, allowing the high-level planner to attend to abstract goals or milestones towards the requested task while the low-level planner attends to the discrete instructions which compose such abstract goals or milestones. Modeling the one or more web applications as a plurality of states and associated actions constrains the space of allowed actions. Thus, when constructing novel action sequences for requested tasks, the high-level planner traces routes through the UI SAS that is ensured to be composed of tested, admissible components. As the behaviors of each of the tested components are known to be stable and predictable, the behavior of the novel task constructed from the tested components should likewise be stable and predictable.

Example 14: The limitations of Example 13, wherein the high-level planner comprises a large language model. The above limitations advantageously enable the high-level planner to navigate the inherent ambiguity with both the user's utterance and the semantic structuring of the UI SAS through the LLM's interpretive flexibility to generate an action sequence compatible with both the request and the model.

Example 15: The limitations of Example 13, wherein the plurality of relevant states and the corresponding plurality of actions within the UI SAS are structured as a plurality of subtasks based on a discrete purpose of the clustered states and actions. The above limitations advantageously enable high-level abstractions of task steps to correlate strongly with the discrete purposes associated with the subtasks, thus strengthening the action sequence interpretation at the abstract, conceptual level with the representations in the UI SAS.

Example 16: The limitations of Example 15, wherein each subtask in the plurality of subtasks terminates in a boundary UI event. The above limitations advantageously enable rule-based structuring of relevant states and corresponding actions into subtasks.

Example 17: The limitations of Example 15, wherein each action in the plurality of actions is assigned a meaningful name determined via a semantic analysis of the semantically discrete purpose of states and actions. The above limitations advantageously enable rule-based assignment of semantic correlations between the relevant states and corresponding actions, thus strengthening the action sequence interpretation at the abstract, conceptual level.

Example 18: A computer program product comprising one or more computer readable storage media, and program instructions collectively stored on the one or more computer readable storage media, the program instructions comprising instructions configured to cause one or more processors to perform the method according to any of Examples 13-17. The computer program product of Example 18 realizes the benefits described with respect to Examples 13-17. The computer program product of Example 18 can advantageously be implemented into a variety of computer program products.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

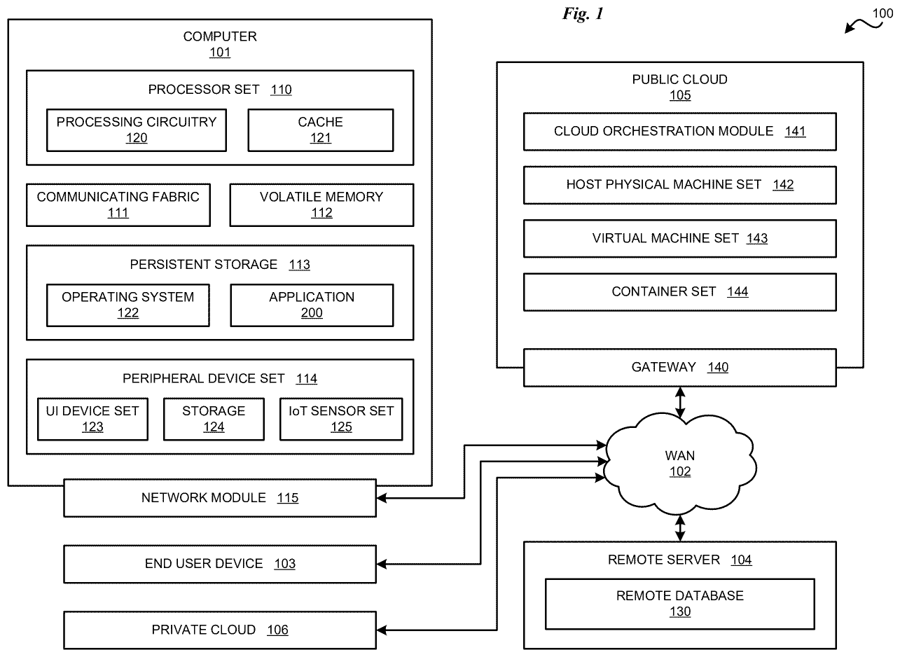

With reference to FIG. 1, this figure depicts a block diagram of a computing environment 100. Computing environment 100 contains an example of an environment for the execution of at least some of the computer code involved in performing the inventive methods, such as application 200 for compositionality in web automation via constrained hierarchical planning over a semantic user-interface state-action space using large language model (LLM) agents. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

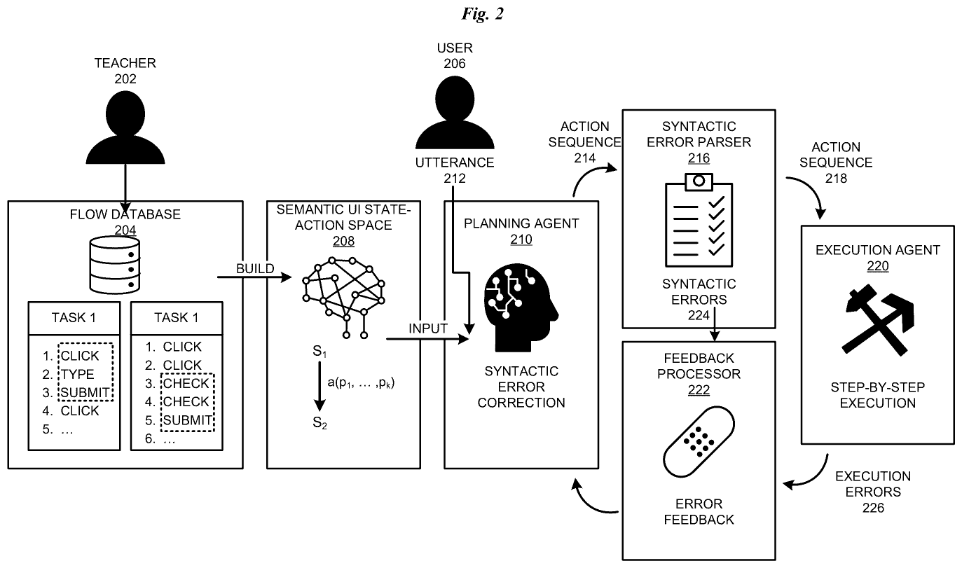

FIG. 2 depicts a block diagram of an example application 200 in accordance with an illustrative embodiment. In the illustrative embodiment teacher 202 provides produces UI flows as records of interactions with elements of web pages that are stored in UI flow database 204. In some embodiments, user 206 may also serve as teacher 202.

Embodiments of the present invention may integrate compositionality components into system teaching as well as execution, enabling the system to automate flows that were not taught end-to-end. Such compositionality components may not depend on the implementation of other system components, so long as they are implementable.

In some embodiments the teacher 202 populates the flow database 204 with UI flows by inputting low-level natural language (NL) instructions. In some embodiments, the teacher 202 populates the flow database 204 by recording a sequence of steps that fulfills an intent in an input utterance. The sequence of steps can be formulated as a sequence of low-level NL instructions.

In some embodiments, the teacher 202 populates the flow database 204 with UI flows via program by demonstration (PbD). For example, the teacher 202 may cue the system to record the series of inputs, keypresses, mouse-clicks, etc., required to perform a particular task, such as recording a macro, to define a UI flow.

With continued reference to FIG. 2, the semantic UI state-action space (UI SAS) 208 serves to ground the planning agent 210 in the web environment and constrain it to follow tested, admissible steps. The UI SAS 208 is a model of a web application capable of representing those aspects of a given application webpage or screen that are relevant to the decisions that can be made at that point for tasks of interest.

In some embodiments, a UI SAS 208 may be a partial model of a web application in that the full functionality of a web application is not represented. Structuring the UI SAS 208 as a partial model may reduce the memory and processing load associated with the UI SAS by only including the functional elements required to execute the UI flows taught to and supported by the model.

In some embodiments, compositionality may be integrated into web automation via a constrained hierarchical planning approach. This may close the environment model gap with the semantic UI SAS 208, while addressing both resiliency and risk. The semantic UI SAS representation of a web application may enable separation of concerns into high- and low-level planning. The high-level planner, such as the planning agent 210, produces the end-to-end action sequence, while the low-level planner, such as the execution agent 220, is responsible for resilient execution. In some embodiments, planning may be implemented with the use of LLMs.

The planning agent 210 is responsible for high-level control and generates the end-to-end plan, i.e., the action sequence to follow in executing the user's 206 intent. In some embodiments, a pre-trained LLM may be implemented as the planning agent 210. In operation, the user 206 invokes the planning agent 210 by typing in an utterance 212 into the dialog. In some embodiments, the utterance 212 is in the form of an instruction issued in natural language that expresses the user's 206 intent to run an automated UI flow, such as “Invite the candidate Jayant Gawali (ID 5072) to apply.” The planning agent 210 receives this utterance 212 as input as well as the current state of the UI SAS 208. From these inputs, the planning agent 210 generates an action sequence 214 to be followed in order to execute the user's intent. The action sequence involves action, some of which may be parametrized. The planning agent will populate those parameters with information provided in the user's utterance 212, for example, an action to search for candidates may include the parameter Candidate ID, in which case, the ID 5072 will be provided as input.

With continued reference to FIG. 2, syntactic error parser 216 parses the action sequence 214 generated by the planning agent 210 for syntax errors 224. In some embodiments, detected errors will trigger a prompt to the user 206. Such prompts may include, but are not limited to, an NL error code expressing the nature and cause of the error, a query to the user 206 requesting clarification in the case of ambiguity or conflicting information in the utterance 212. For example, the user 206 may receive a prompt stating “The entry for ‘candidate Jayant Gawali’ is associated with (ID 5027) rather than (ID 5072). Would you like to proceed by inviting candidate Jayant Gawali (ID 5027) to apply?” Upon confirmation for the user 206, the planning agent 210 may regenerate the action sequence 214.

For the above example, the planning-validation loop may produce the action sequence 214 as follows:
home (recruiting): Landing Page-->Recruiting
click_candidates( ): Recruiting-->Candidates
search_by_candidate_id(5027): Candidates-->Candidate Search Results
click_jobs_applied( ): Candidate Search Results-->Job Applicant Profile
invite_candidate_to_apply( ): Job Applicant Profile-->Job Applicant Profile

In some embodiments, each action in the action sequence 214 may then be substituted for corresponding NL instructions that were used to teach the app flows. In some embodiments, user 206 can then validate the entire instruction sequence, for example, by clicking Yes to run the new flow end to end.

In some embodiments, the feedback processor 222 may respond to detected syntax errors 224 by providing feedback to the planning agent 210. The planning agent 210, in turn, reinterprets the utterance 212 in favor of a better aligned semantic interpretation that obviates the error. Thus, syntactically correct output of the planning agent 210, which is amenable to syntactic validation of syntactic error parser 216, is given preference and the action sequence 214 is regenerated on that basis.

The syntactically validated action sequence 218 is then passed to the execution agent 220 which follows through the steps of the syntactically validated action sequence 218. In some embodiments, the execution agent 220 may be a low-level LLM planner to resiliently execute each primitive UI interaction. Execution by the execution agent 220 may dynamically generate execution errors 226, for example, when there are conflicting filter fields because previous filters have not been cleared first. The feedback processor 222 tracks the execution errors 226 and sends error feedback, if any, back to the planning agent 210 to update the action sequence as necessary.

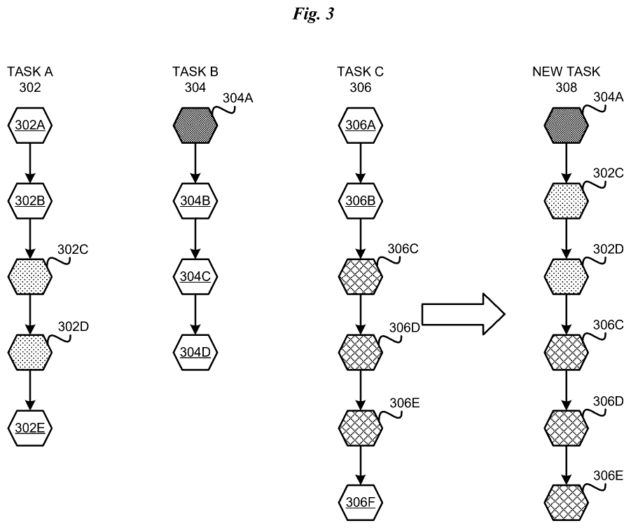

With reference to FIG. 3, this figure depicts a block diagram of a high-level conceptual framework by which compositionality in UI flows may be understood. In the illustrative embodiment, task A 302 is a UI flow composed of five (5) primitive UI interactions 302 a-e. Similarly, task B 304 is composed of four (4) primitive UI interactions 304 a-d and task C 306 is composed of six (6) primitive UI interactions 306 a-f. Such UI flows may be stored in a flow database 204 as discussed with reference to FIG. 2. As used herein, an “action” consists of one or more primitive UI interactions that, collectively, complete a semantical discrete purpose within a complete task. As such, each an action (eᵢ_{₁}, . . . eᵢ_{ₖ}) corresponds to a sub-sequence of primitive UI interactions eᵢ_{ⱼ} (e.g., CLICK, TYPE, or SUBMIT) within the trace of a UI flow: [e₁][e₂ e₃ e₄][ . . . ][eₙ₋₁ eₙ]. Each action terminates in a boundary UI event e₁, e₄, . . . , eₙ. Examples of boundary UI events include, but are not limited to: submit, ‘OK’/‘Leave Page’ confirms, click (link, button, tab), select (menu/table item). Task A 302 includes an action consisting of the primitive UI interactions 302c-d, task B 304 includes an action consisting of the primitive UI interaction 304a, while task C 306 includes an action consisting of the primitive UI interactions 306c-e.

With continued reference to FIG. 3, when a request for a new task 308 is received, rather than generating an end-to-end, one-step-at-a-time UI flow from scratch, the new task 308 may be assembled from pre-existing actions of UI flows stored in the flow database 204. In the case of illustrative embodiment, the new task is composed of three actions consisting of the primitive UI interactions 304a, 302c-d, and, finally, 306c-e.

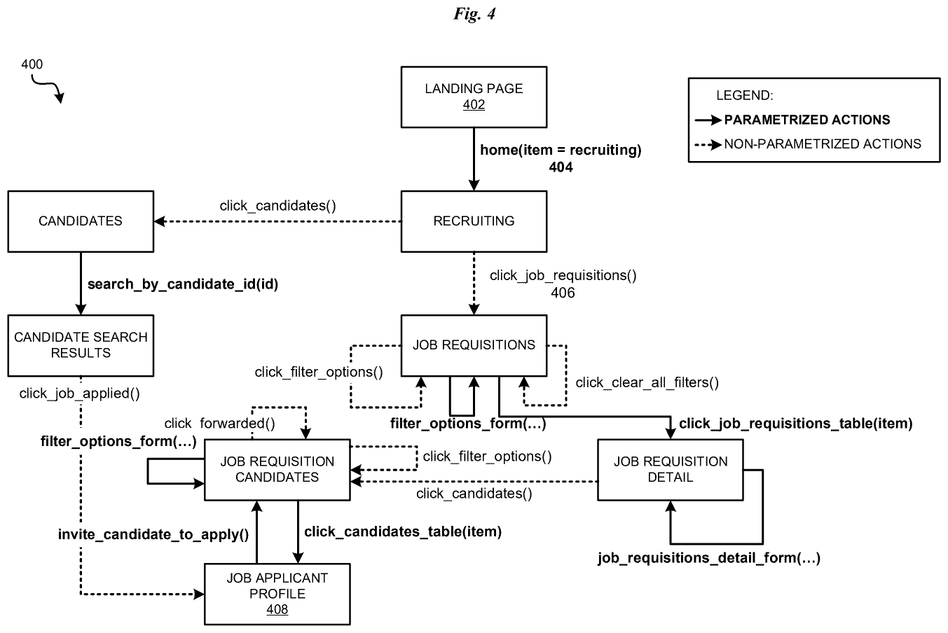

With reference to FIG. 4, this figure depicts an example semantic UI state-action space 400 (semantic UI SAS) in accordance with an illustrative embodiment. In the illustrated embodiment, the semantic UI SAS 400 incorporates the UI flows for the following user tasks:

Show me all candidates for the job requisition Project Manager (ID 2928).
View the job John Sen (ID 8752) applied to.
Edit the status of the job requisition Management and Planning (ID 2867) to Vacancy Cancelled and then close it.
Invite the candidate from Mexico to apply to job requisition Associate Professional (ID 3321).
Show me the forwarded candidates for the job requisition Associate Professional (ID 3321).

The semantic UI SAS 400, as depicted, is a visual representation of the semantic UI SAS 208 of FIG. 2. In the illustrated embodiment, the semantic UI SAS 400 is shown as a collection of titled nodes, representing states, and titled edges, representing actions. For example, in the illustrated embodiment, “Landing Page” 402 represents a state, while “home (item=recruiting)” 404 represents an action whose parameter “item” has been assigned the value “recruiting”. A “state”, as used herein, represents known and relevant information about the condition of the web application. In some embodiment, the state may correspond to a webpage DOM tree, its URL, a collection of DOM tree leaf nodes, a deep link, a screenshot, and the like, or may be associated with a partial set of such contents (e.g., DOM elements). A state is associated with relevant information in that a change within a web application having no function impact would not represent a separate state. For example, two screenshots of the same webpage with switched banners will represent the same state, though the screenshots differ.

In some embodiments, a hierarchy of states with generalization/specialization relationships may be created. As an example, a web application may include a tab bar that is always available in the application, regardless of the state of the application, from which every kind of activity available in the application can be accessed. In some embodiments, such a set of ubiquitous functionalities may be represented as a “super-state”, with tab-click actions going to the appropriate activity, obviating the necessity to put these actions on every state, and considerably reducing the size of the state-action space.

States can have associated variables, which carry information required to carry out some actions. For example, a state may be associated with a specific entity, like the result of a search or browse operation, and actions on that state will refer to that entity.

Identifying states based on a limited number of examples is challenging and requires more information than just the controls available on the page. For example, within the Salesforce web application, there exists an “Opportunities” tab that can show multiple views, including the dynamic “Recently Viewed”. The possible operations on all views are the same, except that the “Recently Viewed” view cannot be edited or modified. Nevertheless, a single-conditioned “Opportunities” state can represent all possible views.

In some embodiments, a page understanding (PU) utility may be utilized to discover these lists and the similarities between their elements in terms of the UI interactions they support. These may then be abstracted into a list of any number of elements. This may enable the creation of a state having any number of conditions, yet still supporting the same actions, thus making for a more concise representation that supports stronger generalizations.

An “action”, as the term is used herein, represents a transformation between a source state and a target state (which may be one and the same). It may be parametrized, for example, an action to fill a web form will include the form fields as parameters. In some embodiments, actions that have different parameters may be considered to be different actions and may lead to different target states.

In some embodiments, actions may be parametrized. For example, with continued reference to FIG. 4 action 404 is parameterized, whereas “click_job_requisition( )” 406 is a non-parameterized action.

Actions can be associated with conditions, i.e., Boolean expressions over the contents and variables of the source state, so that the action can be taken only when the condition is satisfied (in which case the action is said to be enabled). For example, a webpage that contains an empty or a populated table may have different actions associated with each of these two conditions.

An action may have parameters, whose types or locations can be restricted, and the condition may refer to parameters of the action as well as elements and variables of the source state. The target state may be parameterized with the values of its variables, if any.

Action parameters may include, but are not limited to, values of input fields/radio buttons/tick choices, list of menu items, e.g., in the SAP job requisition type menu, we find No Selection, Standard, Evergreen, Child of Evergreen as menu options.

Examples of action parameters that are associated with interactive UI elements include but are not limited to: input fields (e.g., search keywords, form fields), radio buttons (mutually exclusive), tick choices, menu/table ‘item’, and the like and combinations thereof.

In some embodiments, the semantic UI SAS 400 may have a textual representation amenable to an planning LLM agent of the following form:

```
States:
  Start
  Job Requisitions
  Job Requisition Detail
  Candidates
Actions:
  admin_center_menu(item): Start → Job Requisitions
    # item values: “Recruiting”
  click_clear_all_filters( ): Job Requisitions → Job Requisitions
  click_filter_options( ): Job Requisitions → Job Requisitions
  filter_options_form(enter_keywords, job_requisition_id, job_requisition_type):
  Job Requisitions → Job Requisitions
    # job_requisition_type values: No Selection, Standard, Evergreen,
    Child of Evergreen
  click_job_requisitions_table(item): Job Requisitions → Job Requisition Detail
    # item values: First, Last, or name of a job requisition entity
  job_requisition_detail_form(status, posting_country, job_country, state,
  employment_type): Job Requisition Detail → Job Requisition Detail
    # status values: Open, Offer, Hired, Hold, Vacancy Cancelled
    # employment_type values: No Selection, Casual, Fixed-term contract,
    Full-time, Part-time
  click_job_requisitions( ): Job Requisition Detail → Job Requisitions
  click_candidates( ): Job Requisition Detail → Candidates
  click_interview( ): Candidates → Candidates
```

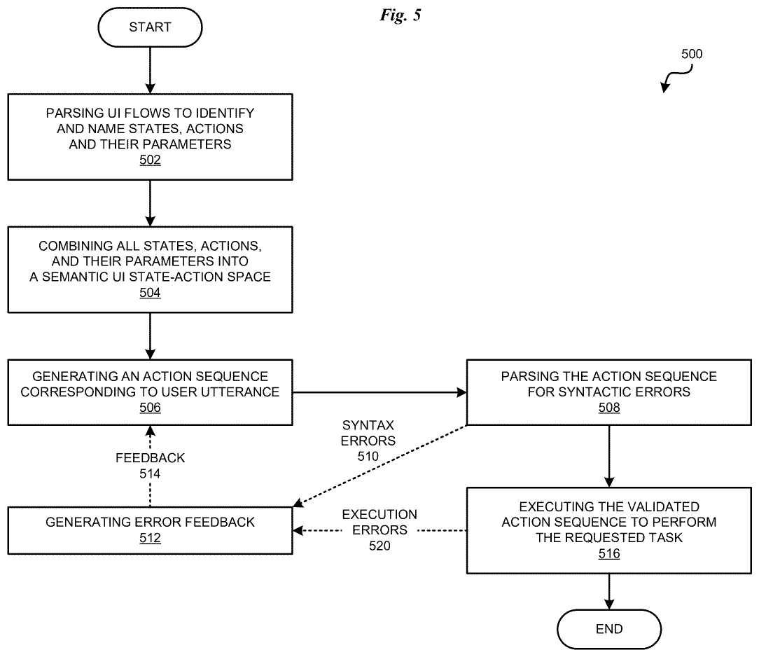

With reference to FIG. 5, this figure depicts a flowchart of an example process 500 for compositionality in web automation via constrained hierarchical planning over a semantic UI state-action space in accordance with an illustrative embodiment. As depicted, at block 502 of the example process 500, a plurality of UI flows stored in a UI flow database, such as the flow database 204 as discussed with reference FIG. 2, are parsed to identify states, actions, and their parameters and name them in accordance with a semantically discrete functionality. In some illustrative embodiments, the UI flow database may be populated by UI flows consisting each of a sequence of primitive UI interactions. In some illustrative embodiments, the UI flow database is populated via program by demonstration to capture UI events. Each UI flow corresponds to a task to be executed within one or more web applications. Each action comprises a plurality of primitive UI interactions that complete a semantically discrete purpose within the task, terminating in a boundary UI event.

As depicted, at block 504 of the example process 500, all the states, actions, and their parameters of the plurality of UI flows are combined into a semantic user interface state-action space (UI SAS), such as the semantic UI SAS 208 of FIG. 2. In some illustrative embodiments, each representation comprises assigning meaningful names to the states and actions (and their parameters) within the web application. In some illustrative embodiments, the meaningful names may be determined via analysis of primitive UI interactions that make up a UI flow, identifying blocks of interactions that designate a single. semantically discrete purpose.

As depicted, at block 506 of the example process 500, a planning agent, such as the planning agent 210 of FIG. 2, generates a sequence of actions from the semantic UI state-action space corresponding to an utterance from a user. In some illustrative embodiments, the utterance may comprise an input intended to convey a single task to be executed within the one or more web applications. In some illustrative embodiments, the utterance may comprise a natural language input. In some illustrative embodiments, generating the action sequence may include the planning agent tracing a path through the semantic UI state-action space. In some illustrative embodiments, the planning agent may comprise a large language model.

As depicted, at block 508 of the example process 500, a syntactic error parser, such as the syntactic error parser 216 of FIG. 2, parses the action sequence for syntax errors 510.

As depicted, at block 512 of the example processes 500, the feedback processor, such as the processor 222 of FIG. 2, receives error notifications from the syntactic error parser and generates feedback 514 to the planning agent to amend the action sequence.

As depicted, at block 516 of the example process 500, an execution agent, such as the execution agent 220 of FIG. 2, executes the validated action sequence to perform the requested task captured by the user's utterance. In some embodiments, execution errors 520 generated in operation are reported as sent back to the feedback processor to generate error feedback at block 512 sent to the planning agent for resolution.

In operational semantics of programs, the concrete program state consists of the values of all the variables that the program can access. The effects of an action are easy to compute in this representation, but it is typically too large to be useful. Practically, some kind of abstraction is applied to the program's concrete states to form abstract states; this abstraction is derived from the operations needed from the representation for a specific purpose.

In a semantic UI SAS, states, actions, and their parameters are assigned meaningful names that capture their utility from the user's perspective. In some embodiments, meaningful names may be assigned by a teacher 202 as depicted in FIG. 2 at the time of training. In some embodiments, such meaningful names may be determined via semantic analysis of the apparent purpose of the series of steps executed within the UI flow. In some embodiments, an LLM may be invoked for the purpose of naming.

For example, a rule-based implementation of the UI SAS that enables both building and updating.
States: URLs up to “?” and stripping IDs.
For example,
My.USPTO
https://auth.uspto.gov/oauth2/aus4g1a57oh3rSfLa4 h7/v1/authorize?client_id=0oaampizx cWh15Rxa4 h7&code_challenge= . . .
In this example, the state may be named “Authorize” according to a rule-based approach.

In some embodiments, the naming of actions within the semantic UI SAS representation may depend upon the categories of the action. Examples of categories of actions may include, but are not limited to, actions involving a single UI event, actions involving a search-submit pattern, actions involving menu/table item selection, and otherwise.

In some embodiments textual representation of the semantic UI SAS may be employed within the few-shot prompt by introducing pseudocode to assist the LLM in setting parameters with the correct values. As used herein, “pseudocode” refers to code-like form for actions written in the code-like manner of functions with blocks of comments but still retains a level of semantic abstraction to be interpreted by the LLM. The pseudocode introduces increased structure beyond what can be found in natural language instructions but retains a level of semantic abstraction which leverages the LLM's contextual sensitivity to remain more flexible and adaptive than hard-coded machine instructions.

As used herein, a “few-shot prompt” refers to a type of input prompt designed to teach or guide a model, such as a large language model, to perform a specific task by providing it with a few examples or demonstrations. Such examples are given directly within the LLM prompt itself before the task is asked. Few-shot prompting involves showing the model a handful of example input-output pairs related to the task you want the model to perform.

In some embodiments of the present invention, a few-shot prompt may take the form of a set of natural language utterances and a corresponding set of pseudocode from which the LLM may ascertain a semantic grammar by which natural language corresponds to pseudocode. The LLM may then be prompted with a new natural language utterance and generate a corresponding sequence of actions based on the ascertained grammar.

Few-shot prompting leverages the LLM's vast pre-training to generalize from these few examples, allowing it to handle tasks even if it hasn't been explicitly fine-tuned for that specific task. After presenting the examples, one then provides a new input, and the model is expected to generate the corresponding output, based on the patterns it has observed in the few examples.

In some embodiments, the planning agent determines the sequence of actions required to complete the user's intended request. As previously taught UI flows are integrated into the semantic UI SAS, states, actions, and their parameters may be identified and connected such that the planning agent may develop new routes through the semantic UI SAS to automate flows that were not taught end to end.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
parsing a UI flow stored in a UI flow database to identify states, actions, and parameters of the actions;
naming each of the identified states, actions, and parameters of the actions according to a semantically discrete functionality of each;
combining the named states, actions, and parameters of the actions into a semantic user interface state-action space (UI SAS);
generating, via a planning agent, a sequence of actions from the semantic UI state-action space corresponding to an utterance from a user, wherein the utterance comprises an input intended to convey a requested task to be executed within one or more web applications;
parsing, via a syntactic error parser, the action sequence for syntax errors;
generating, via the syntactic error parser, a feedback to the planning agent regarding the syntax errors;
generating, via the planning agent, a validated action sequence based on the feedback; and
executing, via an execution agent, the validated action sequence to perform the requested task within the one or more web applications.

2. The computer-implemented method of claim 1, wherein the UI flow corresponds to a task to be executed within the one or more web applications.

3. The computer-implemented method of claim 1, wherein each of the actions comprises a plurality of primitive UI interactions that complete a semantically discrete purpose within the task, terminating in a boundary UI event.

4. The computer-implemented method of claim 1, further comprising generating, via the execution agent, the feedback to the planning agent regarding execution errors generated in operation.

5. The computer-implemented method of claim 1, wherein naming further comprises determining a meaningful names for the identified states, actions, and parameters of the actions via a semantic analysis of a semantically discrete purpose of blocks of primitive UI interactions.

6. The computer-implemented method of claim 1, wherein generating the action sequence further comprises tracing, via the planning agent, a path through the semantic user interface state-action space (UI SAS).

7. The computer-implemented method of claim 1, wherein the utterance from the user comprises a natural language input.

8. The computer-implemented method of claim 1, wherein the planning agent comprises a large language model.

9. The computer-implemented method of claim 1, wherein the flow database is populated by UI flows consisting of sequences of primitive UI interactions that implement end to end an intent of a user utterance.

10. The computer-implemented method of claim 1, the flow database is populated via program by demonstration to capture UI events.

11. A computer program product comprising one or more computer readable storage media, and program instructions collectively stored on the one or more computer readable storage media, the program instructions executable by a processor to cause the processor to perform operations comprising:
parsing a UI flow stored in a UI flow database to identify states, actions, and parameters of the actions;
naming each of the identified states, actions, and parameters of the actions according to a semantically discrete functionality of each;
combining the named states, actions, and parameters of the actions into a semantic user interface state-action space (UI SAS);
generating, via a planning agent, a sequence of actions from the semantic UI state-action space corresponding to an utterance from a user, wherein the utterance comprises an input intended to convey a requested task to be executed within one or more web applications
parsing, via a syntactic error parser, the action sequence for syntax errors;
generating, via the syntactic error parser, a feedback to the planning agent regarding the syntax errors;
generating, via the planning agent, a validated action sequence based on the feedback; and
executing, via an execution agent, the validated action sequence to perform the requested task within the one or more web applications.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein generating the action sequence further comprises tracing, via the planning agent, a path through the semantic user interface state-action space (UI SAS).

15. A computer system comprising a processor and one or more computer readable storage media, and program instructions collectively stored on the one or more computer readable storage media, the program instructions executable by the processor to cause the processor to perform operations comprising:
parsing a UI flow stored in a UI flow database to identify states, actions, and parameters of the actions;
naming each of the identified states, actions, and parameters of the actions according to a semantically discrete functionality of each;
combining the named states, actions, and parameters of the actions into a semantic user interface state-action space (UI SAS);
generating, via a planning agent, a of actions from the semantic UI state-action space corresponding to an utterance from a user, wherein the utterance comprises an input intended to convey a requested task to be executed within one or more web applications;
parsing, via a syntactic error parser, the action sequence for syntax errors;
generating, via the syntactic error parser, a feedback to the planning agent regarding the syntax errors;
generating, via the planning agent, a validated action sequence based on the feedback; and
executing, via an execution agent, the validated action sequence to perform the requested task within the one or more web applications.

16. The computer system of claim 15, wherein naming further comprises determining a meaningful names for the identified states, actions, and parameters of the actions via a semantic analysis of the semantically discrete purpose of blocks of primitive UI interactions.

17. The computer system of claim 15, wherein generating the action sequence further comprises tracing, via the planning agent, a path through the semantic user interface state-action space (UI SAS).

18. A computer-implemented method comprising:
tracing, via a high-level planner, a route through a user interface state-action space (UI SAS) corresponding to a user-provided utterance that conveys a requested task to be executed,
wherein the UI SAS comprises a model representing a plurality of relevant states of one or more web applications and a corresponding plurality of actions that can be made from the plurality of states;
generating, via the high-level planner, an action sequence for a low-level planner comprising a sequence of states of the plurality of states and a corresponding sequence of actions of the plurality of actions
generating, via the validator, a validated action sequence by parsing the action sequence for syntactic discrepancies within the sequence of states and the corresponding sequence of actions; and
executing, via a low-level planner, the validated action sequence to perform the requested task within one or more web applications.

19. The computer-implemented method of claim 18, wherein the high-level planner comprises a large language model.

20. The computer-implemented method of claim 18, wherein the plurality of relevant states and the corresponding plurality of actions within the UI SAS are structured as a plurality of subtasks based on a semantically discrete purpose of the plurality of relevant states and the corresponding plurality of actions.

21. The computer-implemented method of claim 20, wherein each subtask in the plurality of subtasks terminates in a boundary UI event.

22. The computer-implemented method of claim 20, wherein each subtask in the plurality of subtasks are assigned meaningful names determined via a semantic analysis of the semantically discrete purpose of the plurality of states and the corresponding plurality of actions.

23. A computer program product comprising one or more computer readable storage media, and program instructions collectively stored on the one or more computer readable storage media, the program instructions executable by a processor to cause the processor to perform operations comprising:
tracing, via a high-level planner, a route through a user interface state-action space (UI SAS) corresponding to a user-provided utterance that conveys a requested task to be executed,
wherein the UI SAS comprises a model representing relevant a plurality of states of one or more web applications and the plurality of actions that can be made from the plurality of states;
generating, via the high-level planner, an action sequence for a low-level planner comprising a sequence of states of the plurality of states and a corresponding sequence of actions of the plurality of actions
generating, via the validator, a validated action sequence by parsing the action sequence for syntactic discrepancies within the sequence of states and the corresponding sequence of actions; and
executing, via a low-level planner, the validated action sequence to perform the requested task within one or more web applications.

24. The computer program product of claim 23, wherein the stored program instructions are stored in a computer readable storage device in a data processing system, and wherein the stored program instructions are transferred over a network from a remote data processing system.

25. The computer program product of claim 23, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.
